(19) United States
(12) Patent Application Publication
(10) Pub. No.: US 2006/0271878 A1
(43) Pub. Date: Nov. 30, 2006

(54) Information processing apparatus capable of displaying a plurality of windows

(75) Inventor: Kazunari Hashimoto, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/411,495

(22) Filed: Apr. 26, 2006

(30) Foreign Application Priority Data
May 24, 2005 (JP) 2005-151037

(51) Int. Cl. G06F 3/00; G06F 17/00

(52) U.S. Cl. 715/781; 715/856

(57) ABSTRACT

According to one embodiment, an information processing apparatus includes an input device, a memory device, a window identifier storage unit which stores, in the memory device, window identifiers which correspond to at least two windows of a plurality of windows, which are designated as to-be-controlled windows by an operation of the input device, and a window control unit which executes a process of switching an active window between the windows corresponding to the window identifiers stored in the memory device, when an event of requesting switch of the active window is input from the input device.

### CROSS-REFERENCE TO RELATED APPLICATIONS

This application is based upon and claims the benefit of priority from Japanese Patent Application No. 2005-151037, filed May 24, 2005, the entire contents of which are incorporated herein by reference.

### BACKGROUND

1. Field

One embodiment of the invention relates to an information processing apparatus capable of displaying a plurality of windows, and a program for use in the apparatus.

2. Description of the Related Art

In general, in an information processing apparatus such as a personal computer, a multi-window system is used. The multi-window system is a window environment which enables windows corresponding to various programs, such as an application program and a utility program, to be displayed on a display screen.

In the multi-window system, a user operates a mouse device to move a mouse pointer onto a target window, and clicks the mouse device, thereby setting this window to be an active window. The active window is a most foreground window among the windows displayed on the display screen, that is, a window which is currently focused and serves as an object of screen scroll, command input or text input.

In order to move the position of the mouse pointer onto the target window, however, the user has to move the mouse device itself on the desk. In a case where the position of a currently active window is at a relatively long distance from the position of the target window that is to be set as a new active window, the distance of necessary movement of the mouse device also increases. Thus, the function of switching the active window by the operation of moving the mouse pointer is not always easy to use for the user.

Jpn. Pat. Appln. KOKAI Publication No. 2005-10984 discloses a technique of switching an active window by simultaneously pressing an “Alt” key and a “Tab” key.

In this active window switching technique using the “Alt” key and “Tab” key, however, switching of the active window is executed between all the windows on the display screen. Thus, when many windows are displayed, the user needs to execute the simultaneous depression of the “Alt” key and “Tab” key many times.

Under the circumstances, there is a demand for realization of a novel function which enables easy switching of an active window between arbitrary windows.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of the external appearance of an information processing apparatus according to an embodiment of the invention;

FIG. 2 is an exemplary block diagram showing an example of the system configuration of the information processing apparatus shown in FIG. 1;

FIG. 3 is an exemplary block diagram showing an example of the functional configuration of a window control utility program which is executed by the information processing apparatus shown in FIG. 1;

FIG. 4 is an exemplary view for describing an example of a window identifier registration process which is executed by the information processing apparatus shown in FIG. 1;

FIG. 5 is an exemplary view showing an example of a process for registering a window identifier corresponding to a window which is displayed on a display device of the information processing apparatus shown in FIG. 1;

FIG. 6 is an exemplary view for describing an example of a window identifier deletion process which is executed by the information processing apparatus shown in FIG. 1;

FIG. 7 is an exemplary view showing an example of a process for deleting a window identifier corresponding to a window which is displayed on the display device of the information processing apparatus shown in FIG. 1;

FIG. 8 is an exemplary view for describing an example of a window switching process which is executed by the information processing apparatus shown in FIG. 1;

FIG. 9 is an exemplary view showing an example of an operation screen which is used in the information processing apparatus shown in FIG. 1;

FIG. 10 is an exemplary view showing another example of the operation screen which is used in the information processing apparatus shown in FIG. 1;

FIG. 11 is an exemplary view showing still another example of the operation screen which is used in the information processing apparatus shown in FIG. 1;

FIG. 12 is an exemplary view for describing an example of a window table which is used in the information processing apparatus shown in FIG. 1;

FIG. 13 is an exemplary flow chart for describing an example of the procedure of the window identifier registration process which is executed by the window control utility program shown in FIG. 3;

FIG. 14 is an exemplary flow chart for describing an example of the procedure of the window identifier deletion process which is executed by the window control utility program shown in FIG. 3;

FIG. 15 is an exemplary flow chart for describing an example of the procedure of the window switching process which is executed by the window control utility program shown in FIG. 3;

FIG. 16 is an exemplary view for describing a modification of the window switching process which is executed by the information processing apparatus shown in FIG. 1;

FIG. 17 is an exemplary view showing still another example of the operation screen which is used in the information processing apparatus shown in FIG. 1; and

FIG. 18 is an exemplary view for describing an example of a window switching mode which is used in the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes an input device, a memory device, a window identifier storage unit which stores, in the memory device, window identifiers which correspond to at least two windows of a plurality of windows, which are designated as to-be-controlled windows by an operation of the input device, and a window control unit which executes a process of switching an active window between the windows corresponding to the window identifiers stored in the memory device, when an event of requesting switch of the active window is input from the input device.

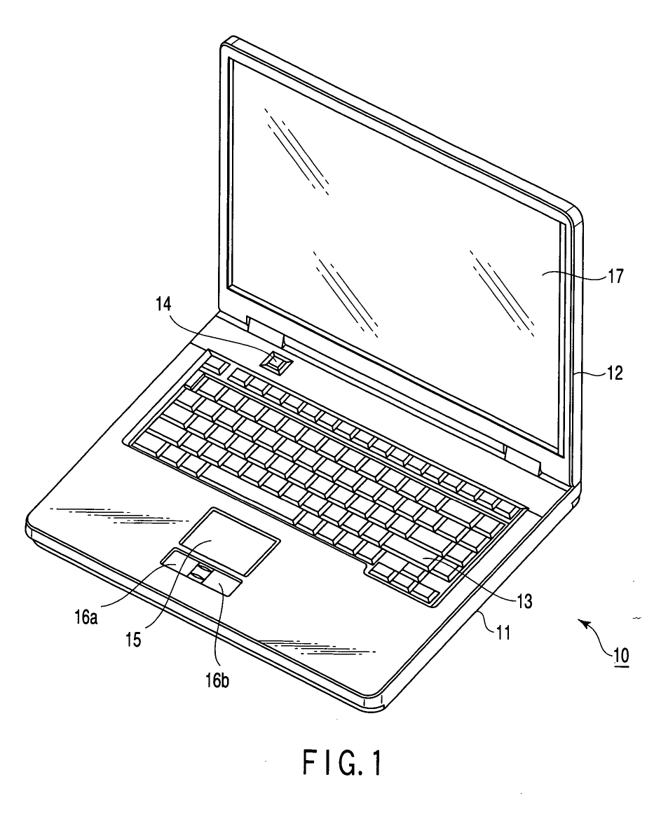

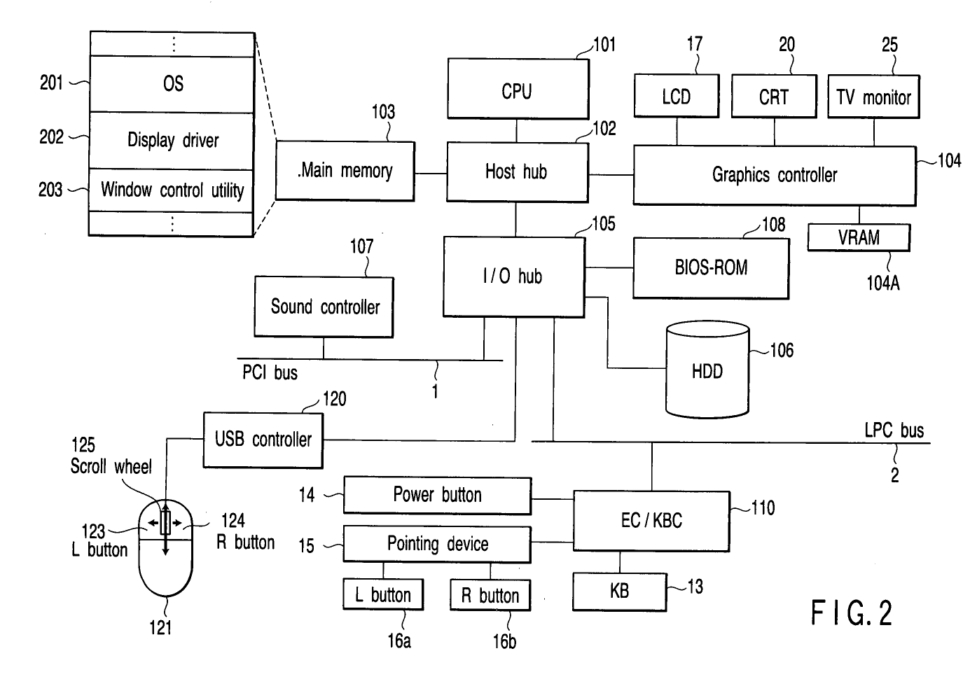

To begin with, the structure of an information processing apparatus according to an embodiment of the invention is described referring to FIG. 1 and FIG. 2. The information processing apparatus is realized, for example, as a notebook personal computer 10.

FIG. 1 is a perspective view of the notebook personal computer 10 in the state in which a display unit is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is attached to the computer main body 11 such that the display unit 12 is freely rotatable between an open position where the top surface of the computer main body 11 is exposed and a closed position where the top surface of the computer main body 11 is covered. The computer main body 11 has a thin box-shaped casing. A keyboard 13, a power button 14 for powering on/off the computer 10, and a touch pad 15 are disposed on the top surface of the computer main body 11.

The touch pad 15 is a pointing device which points an arbitrary position on the display screen of the LCD 17, and designates the position of a mouse pointer (also referred to as “mouse cursor”) which is to be displayed on the display screen. In accordance with the operation of the touch pad 15, the mouse pointer moves on the display screen. The touch pad 15 is provided with a left button switch (L button) 16a and a right button switch (R button) 16b. The left button switch 16a is a button switch for choosing an item on the display screen, which is currently designated by the mouse pointer. The right button switch 16b is a button switch having a function of bringing up menu items which are indicative of a list of operational functions.

The computer 10 supports a multi-window system which displays a plurality of windows on the display screen of the LCD 17. In some cases, the user performs an input operation of data, such as a command and text, on the active window, while viewing other inactive windows. The active window, as described above, is a most foreground window and is the object of command input and text input.

Next, referring to FIG. 2, the system configuration of the computer 10 is described.

The computer 10, as shown in FIG. 2, includes a CPU 101, a host hub 102, a main memory 103, a graphics controller 104, an I/O hub 105, a hard disk drive 106, a sound controller 107, a BIOS-ROM 108, and an embedded controller/keyboard controller IC (EC/KBC) 110.

The CPU 101 is a processor that is provided in order to control the operation of the computer 10. The CPU 101 executes an operating system (OS) 201 and various applications/utility programs, which are loaded from the hard disk drive (HDD) 106 into the main memory 103. The OS 201 includes a window system for displaying a plurality of windows on the display screen. The CPU 101 also executes a BIOS (Basic Input/Output System) which is stored in the BIOS-ROM 108.

In the computer 10, a window control utility program 203 is preinstalled as one of utility programs. The window control utility program 203 is a program for executing a process for switching an active window between windows which are designated in advance as to-be-switched objects. The window control utility program 203 may be realized, for example, as a TSR (terminate-and stay-resident program). A display driver 202 is software for controlling the graphics controller 104.

The host hub 102 is a bridge device for connecting the local bus of the CPU 101 and the I/O hub 105. The host hub 102 incorporates a memory controller which access-controls the main memory 103.

The graphics controller 104 controls the LCD 17, a CRT (cathode-ray tube) monitor 20 and a TV monitor 25, which are used as display monitors of the computer 10. The graphics controller 104 has a video memory (VRAM) 104A, and displays display data, which is written in the video memory (VRAM) 104A by the OS/application program, on the LCD 17, CRT monitor 20 and TV monitor 25.

The I/O hub 105 controls the devices on a PCI (Peripheral Component Interconnect) bus 1 and the devices on an LPC (Low Pin Count) bus 2. The I/O hub 105 incorporates an IDE (Integrated Drive Electronics) controller for controlling the HDD 106. A USB (Universal Serial Bus) controller 120 is connected to the I/O hub 105.

The USB controller 120 has a function of controlling a USB device which is connected to a USB port that is provided on the computer main body 11. A USB mouse device 121, for instance, is connected, where necessary, to the USB port of the computer 10. The USB mouse device 121 is a pointing device and has a left button switch (L button) 123, a right button switch (R button) 124 and a scroll wheel 125. The left button switch 123 has the same function as the above-described left button switch 16a. The right button switch 124 has the same function as the above-described right button switch 16b. The scroll wheel 125 is vertically rotatably supported on the body of the USB mouse 121. In addition, the scroll wheel 125 is supported on the body of the USB mouse 121 so as to be slightly slidable to the left and right directions.

The sound controller 107 is connected to the PCI bus 1. The sound controller 107 is a PCI device functioning as a sound source. The embedded controller/keyboard controller IC (EC/KBC) 110 is connected to the LPC bus 2.

The embedded controller/keyboard controller IC (EC/KBC) 110 is a 1-chip microcomputer in which an embedded controller for power management and a keyboard controller for controlling the keyboard (KB) 13 and pointing device (touch pad) 15 are integrated. The embedded controller/keyboard controller IC (EC/KBC) 110 has a function of powering on/off the computer 10 in response to the user's operation of the power button 14.

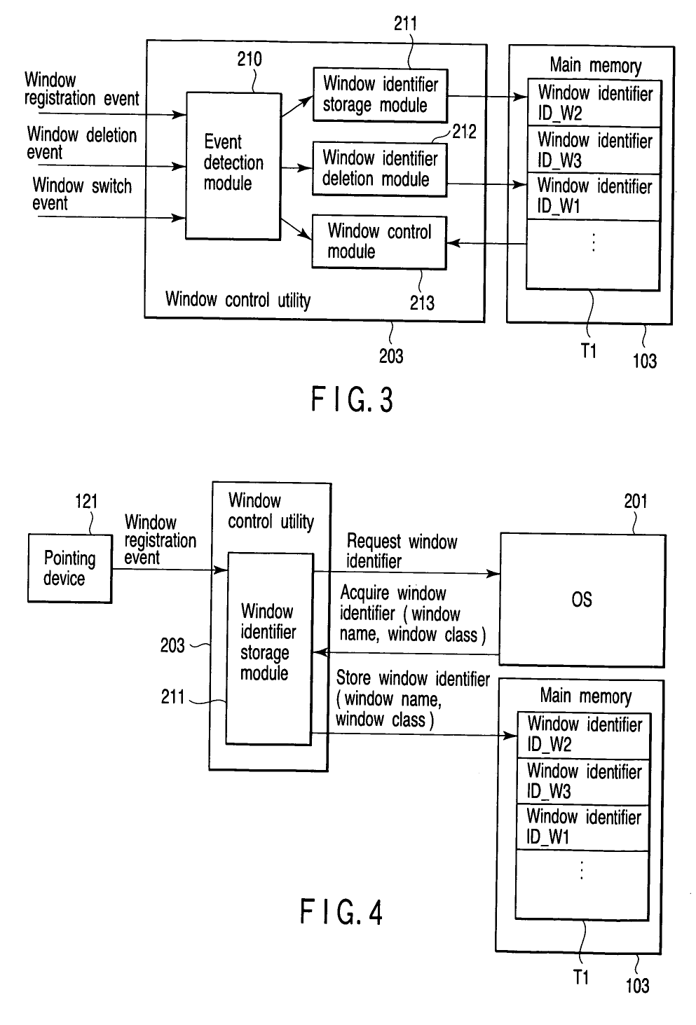

Next, referring to FIG. 3, the functional configuration of the window control utility program 203 is described.

The window control utility program 203 comprises an event detection module 210, a window identifier storage module 211, a window identifier deletion module 212 and a window control module 213. The event detection module 210, window identifier storage module 211, window identifier deletion module 212 and window control module 213 are software modules.

The event detection module 210 has a function of detecting an event (window registration event, window deletion event, active window switch event) which is input by the operation of the input device (keyboard 13, touch pad 15 or USB mouse 121). The window registration event is an event which instructs that a window selected from among a plurality of windows displayed on the LCD 17 should be registered as a to-be-controlled window. The window deletion event is an event which instructs that a window selected from among the windows, which are registered as to-be-controlled windows, should be excluded from the to-be-controlled windows. The active window switch event is an event which instructs execution of a process for switching the active window between the windows that are registered as to-be-controlled windows.

The window identifier storage module 211 stores, in a table T1 of the main memory 103, window identifiers which correspond to at least two windows that are designated as to-be-controlled windows by the operation of the input device (keyboard 13, touch pad 15 or USB mouse 121). Specifically, when the event detection module 210 detects the input of a window registration event, the window identifier storage module 211 stores, in the table T1 of the main memory 103, window identifier which corresponds to window designated by the window registration event. The window identifier is information for uniquely identifying each of a plurality of windows. The window identifier is composed of information such as a window name and a window class.

The window identifier deletion module 212 deletes, from the table T1, a window identifier which corresponds to a window that is designated to be deleted from the to-be-controlled windows by the operation of the input device (keyboard 13, touch pad 15 or USB mouse 121). Specifically, when the event detection module 210 detects the input of a window deletion event, the window identifier deletion module 212 deletes from the table T1 a window identifier which corresponds to the window designated by the window deletion event.

When the event detection module 210 detects the input of an active window switch event, the window control module 213 executes a process of switching the active window between the windows corresponding to the window identifiers stored in the table T1. For example, if window identifiers ID_W1, ID_W2 and ID_W3 corresponding to three windows W1, W2 and W3 are stored in the table T1, the window control module 213 successively switches the active window between the three windows W1, W2 and W3 each time the input of the active window switch event is detected. Specifically, if the active window switch event is input in the state in which the window W1 is in the active state, the window control module 213 sets the window W2 to be the active window. If the active window switch event is input in the state in which the window W2 is in the active state, the window control module 213 sets the window W3 to be the active window. If the active window switch event is input in the state in which the window W3 is in the active state, the window control module 213 sets the window W1 to be the active window.

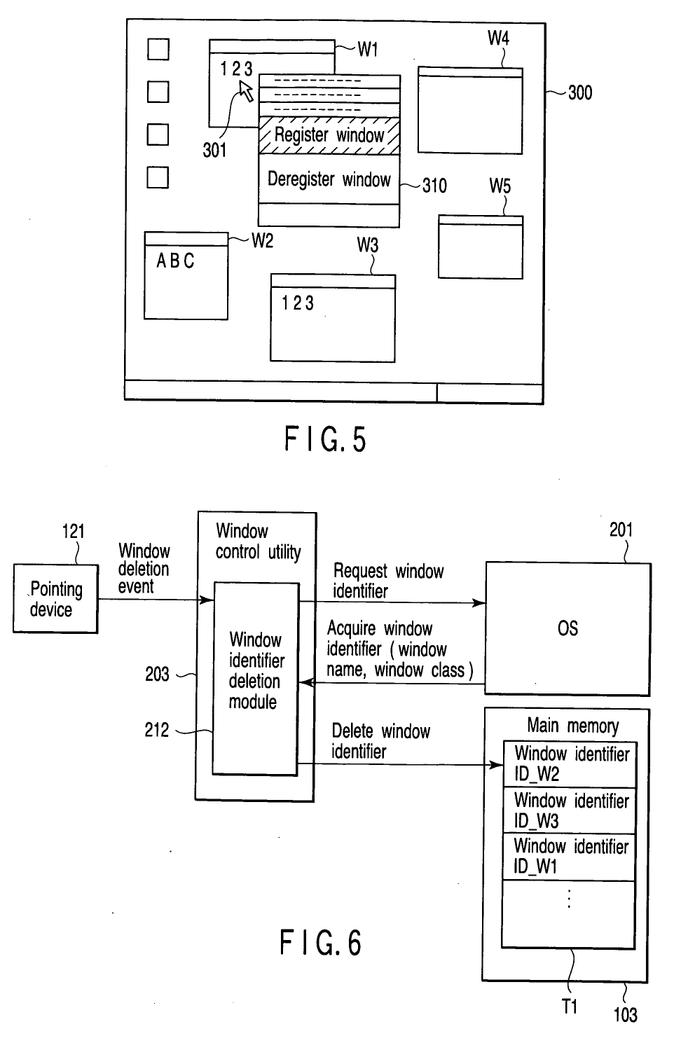

Next, referring to FIG. 4 and FIG. 5, a description is given of the window identifier registration process which is executed by the window identifier storage module 211.

The window identifier registration process is executed when the input of the window registration event is detected. For example, as shown in FIG. 5, the input operation of the window registration event is executed by using an operation menu 310 which is displayed on the display screen in response to an operation (right click operation) of the right button switch 16b of the touch pad 15 or the right button switch 124 of the mouse 121. The operation menu 310 displays items corresponding to a “window registration” function and a “window deregistration” function, in addition to items corresponding to some standard functions which are provided by the OS 201. If the “window registration” item is selected by the user's operation of the input device (keyboard 13, touch pad 15 or mouse 121), the event detection module 210 detects the input of the window registration event.

When the input of the window registration event is detected, the window identifier storage module 211 of the window control utility program 203 sends to the OS 201 a message for requesting a window identifier of the window designated by the right click operation (or the window located under the mouse cursor). All windows on the display screen are managed by the OS 201. The OS 201 sends a window identifier (window name or window class name) of the window designated by the right click operation (or the window located under the mouse cursor) to the window identifier storage module 211. In this manner, the window identifier storage module 211 acquires from the OS 201 the window identifier of the window that is designated by the window registration event. Thereafter, the window identifier storage module 211 stores the acquired window identifier in the table T1 of the memory 103.

For example, as shown in FIG. 5, if the “window registration” item is selected in the state in which the window W1 is designated by the right click operation, the window identifier storage module 211 acquires from the OS 201 the window identifier ID_W1 corresponding to the window W1 and stores the acquired window identifier ID_W1 in the table T1.

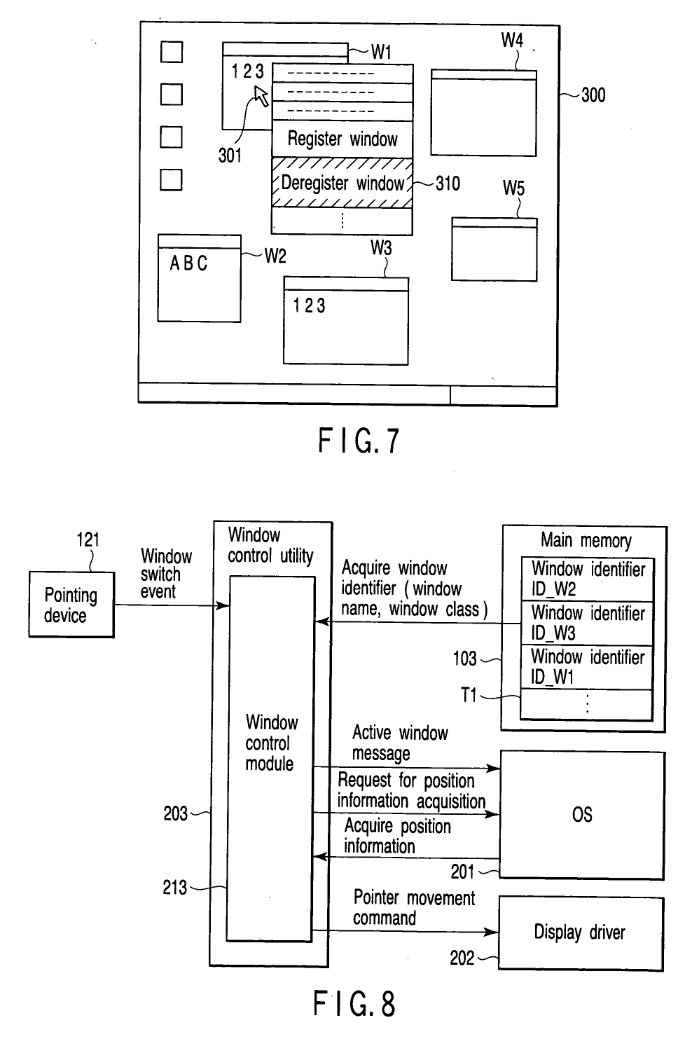

Next, referring to FIG. 6 and FIG. 7, a description is given of the window identifier deletion process which is executed by the window identifier deletion module 212.

The window identifier deletion process is executed when the input of the window deletion event is detected. For example, as shown in FIG. 7, if the “window deregistration” item on the operation menu 310 is selected by the user's operation of the input device (keyboard 13, touch pad 15 or mouse 121), the event detection module 210 detects the input of the window deletion event.

When the input of the window deletion event is detected, the window identifier deletion module 212 of the window control utility program 203 sends to the OS 201 a message for requesting a window identifier of the window designated by the right click operation (or the window located under the mouse cursor). The OS 201 sends a window identifier (window name or window class name) of the window designated by the right click operation (or the window located under the mouse cursor) to the window identifier deletion module 212. In this manner, the window identifier deletion module 212 acquires from the OS 201 the window identifier of the window that is designated by the window deletion event. Thereafter, the window identifier deletion module 212 deletes the acquired window identifier from the table T1 of the memory 103, and excludes the window corresponding to the acquired window identifier from the objects of switching of the active window.

For example, as shown in FIG. 7, if the “window deregistration” item is selected in the state in which the window W1 is designated by the right click operation, the window identifier deletion module 212 acquires from the OS 201 the window identifier ID_W1 corresponding to the window W1 and deletes the acquired window identifier ID_W1 from the table T1.

Next, referring to FIG. 8, a description is given of the window switch process which is executed by the window control module 213.

The window switch process is executed when the input of the active window switch event is detected. There are two kinds of active window switch events, that is, a first event and a second event.

The first event is an event which instructs that the active window should be switched between the windows registered as to-be-controlled windows in a first order. The second event is an event which instructs that the active window should be switched between the windows registered as to-be-controlled windows in an order reverse to the first order.

Each time the input of the first event is detected, the window control module 213 successively sets each of the windows, which correspond to the window identifiers stored in the table T1, to be the active window in the same order as the order of registration of the window identifiers in the table T1. For example, if the window identifiers ID_W2, ID_W3 and ID_W1 are registered in the table T1 in the order of window identifiers ID_W2, ID_W3 and ID_W1, the window control module 213 sets the windows W2, W3 and W1 to be the active window in this order each time the input of the first event is detected.

On the other hand, each time the input of the second event is detected, the window control module 213 successively sets each of the windows, which correspond to the window identifiers stored in the table T1, to be the active window in an order reverse to the order of registration of the window identifiers in the table T1. For example, if the window identifiers ID_W2, ID_W3 and ID-W1 are registered in the table T1 in the order of window identifiers ID_W2, ID-W3 and ID_W1, the window control module 213 sets the windows W1, W3 and W2 to be the active window in this order each time the input of the second event is detected.

For example, when the scroll wheel 125 is shifted to the right by the user, the event detection module 210 detects that the first event is input. When the scroll wheel 125 is shifted to the left by the user, the event detection module 210 detects that the second event is input.

Instead of the operation of shifting the scroll wheel 125 to the left/right, it is possible to use a combination of a preset specific key on the keyboard 13 and the right button switch 16b or right button switch 124 for the input of the first event, and to use a combination of the specific key and the left button switch 16a or left button switch 123 for the input of the second event.

When the input of the active window switch event (first event or second event) is detected, the window control module 213 selects the window identifier, which corresponds to the window that is to be set as the next active window, from among the window identifiers stored in the table T1, and acquires the selected window identifier from the table T1. The window control module 213 sends to the OS 201 a message (active window message) for requesting that the window corresponding to the acquired window identifier be set to be the active window. The active window message includes the acquired window identifier as an argument. The OS 201 sets the window, which corresponds to the window identifier included in the active window message, to be the active window.

Subsequently, the window control module 213 sends to the OS 201 a message for requesting position information (e.g. coordinates information) indicative of the position of the window corresponding to the acquired window identifier on the display screen. Thereby, the window control module 213 acquires from the OS 201 the position information of the window corresponding to the acquired window identifier. Then, the window control module 213 sends to the display driver 202 a command to move the mouse cursor to the position on the display screen, which is designated by the acquired position information. According to the received command, the display driver 202 moves the mouse cursor. Thereby, the mouse cursor can be displayed on the window that is the new active window, as in the case where the active window is switched by the movement of the mouse cursor and the click operation.

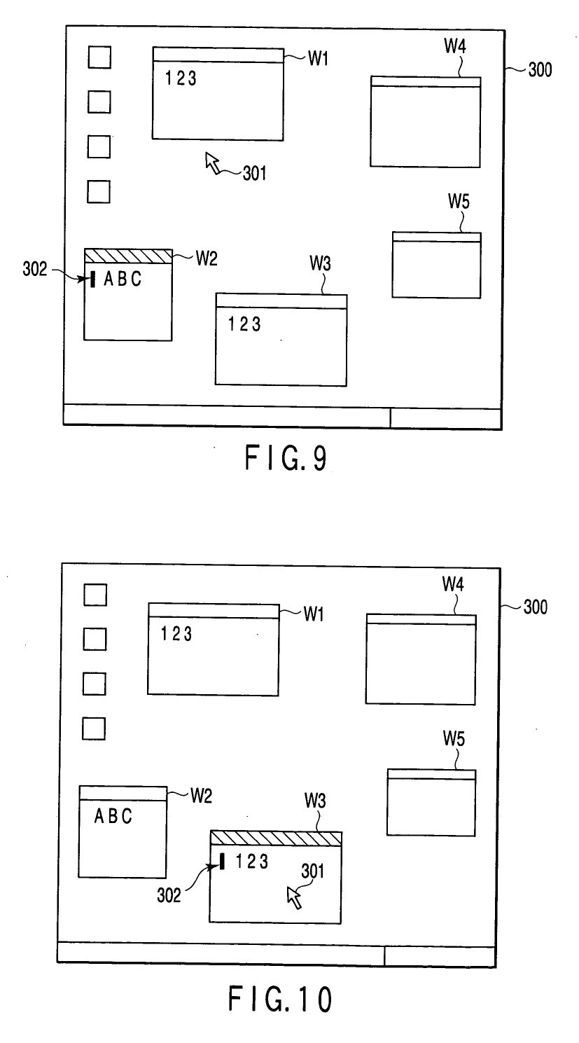

Next, the content of the active window switch process is described in detail with reference to FIG. 9 to FIG. 11.

FIG. 9 shows an example of a display screen 300 of the LCD. The display screen 300 displays windows W1 to W5 and mouse cursor 301. An input cursor 302 is displayed on the active window. The input cursor 302 indicates a position for text input. Assume now that the window identifiers ID_W2, ID_W3 and ID_W1 are registered in this order in the table T1. The objects of switch of the active window are windows W1 to W3. Windows W4 and W5 are excluded from the objects of switch of the active window.

If the first event is input in the state in which the window W2 corresponding to the window identifier W2 is the active window, the active window is switched from the window W2 corresponding to the window identifier ID_W2 to the window W3 corresponding to the window identifier ID_W3, as shown in FIG. 10. At this time, the input cursor 302 is moved onto the window W3, and the mouse cursor 301 is also moved onto the window W3. The movement of the input cursor 302 is executed by the OS 201. The movement of the mouse cursor 301 is executed under the control of the window control module 213.

By this active window switch process, the user can switch the active window without performing the operation of moving the position of the mouse 121 itself on the desk, and can instantaneously move the mouse cursor 301 onto the window that has become the new active window.

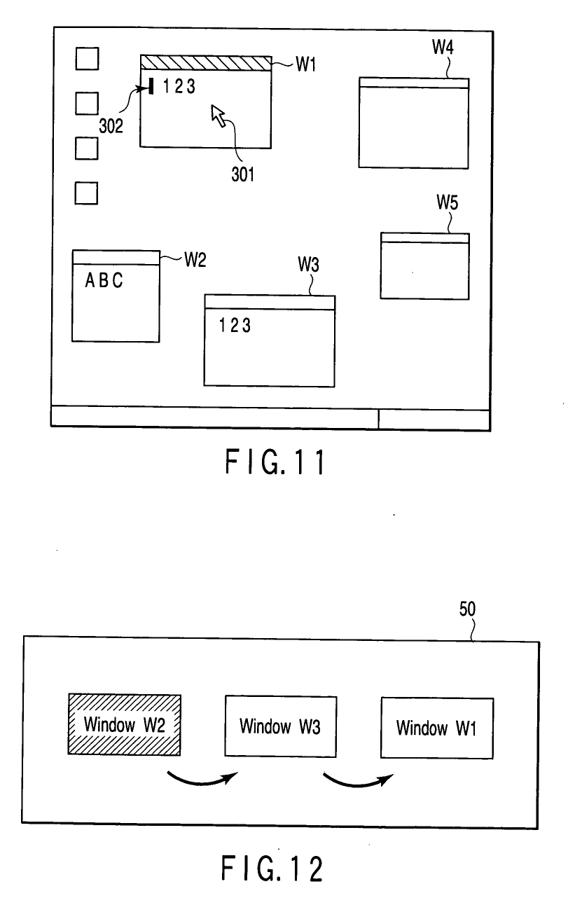

In FIG. 10, if the first event is input once again, the active window is switched from the window W3 corresponding to the window identifier ID_W3 to the window W1 corresponding to the window identifier ID_W1, as shown in FIG. 11. At this time, the input cursor 302 is moved onto the window W1, and the mouse cursor 301 is also moved onto the window W1.

A dialog box 50, as shown in FIG. 12, may be displayed on the LCD 17. The dialog box 50 displays a list of icons corresponding to the window identifiers that are stored in the table T1. In FIG. 12, the icon corresponding to the window W2 is turned on. This indicates that the window W2 is currently the active window.

For example, the dialog box 50 is displayed when the user presses the right button switch 16b or right button switch 124 while pressing a specific key. In the dialog box 50, the icon corresponding to the currently active window is turned on. If the user presses once again the right button switch 16b or right button switch 124 while pressing the specific key, the icon of the window W2 is turned off and the icon of the window W3 is turned on. In this state, if the user releases the finger from the specific key, the window W3 is set to be the active window.

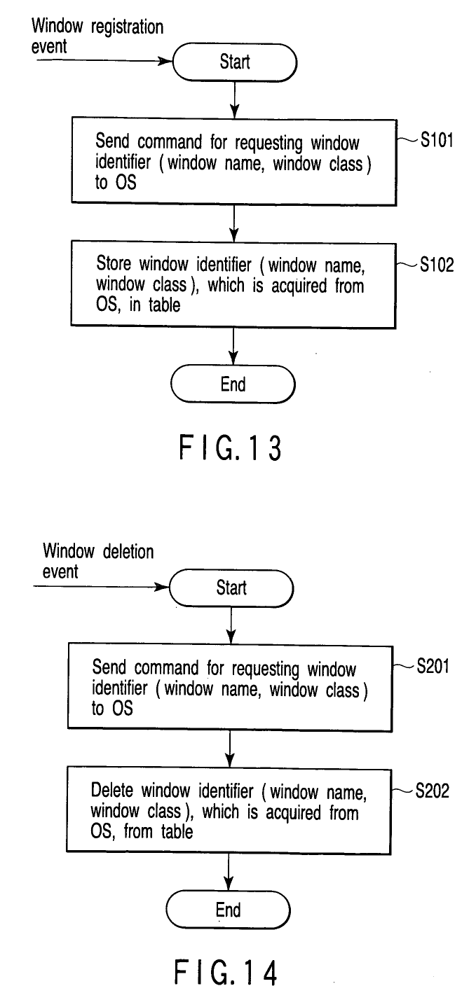

Next, referring to a flow chart of FIG. 13, a description is given of an example of the window identifier registration process which is executed by the window control utility program 203.

If the window registration event is input, the window control utility program 203 sends to the OS 201 a command to request a window identifier (window name or window class name) corresponding to the window designated by the window registration event, and acquires from the OS 201 the window identifier corresponding to the window that is designated by the window registration event (step S101). Subsequently, the window control utility program 203 stores the window identifier (window name, window class), which is acquired from the OS 201, in the table T1 (step S102).

Next, referring to a flow chart of FIG. 14, a description is given of an example of the window identifier deletion process which is executed by the window control utility program 203.

If the window deletion event is input, the window control utility program 203 sends to the OS 201 a command to request a window identifier (window name or window class name) corresponding to the window designated by the window deletion event, and acquires from the OS 201 the window identifier corresponding to the window that is designated by the window deletion event (step S201). Subsequently, the window control utility program 203 deletes the window identifier, which is acquired from the OS 201, from the table T1 (step S202).

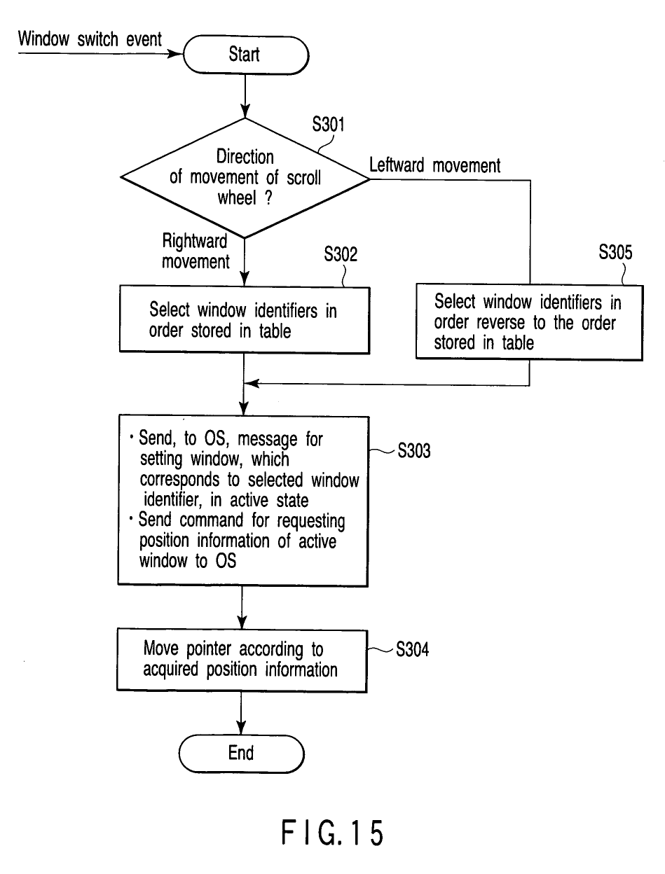

Next, referring to a flow chart of FIG. 15, a description is given of an example of the window switch process which is executed by the window control utility program 203.

If the window switch even is input, the window control utility program 203 determines whether the input event is the first event, which occurs due to the rightward shift operation of the scroll wheel 125, or the second event, which occurs due to the leftward shift operation of the scroll wheel 125 (step S301).

When it is determined that the scroll wheel 125 is shifted to the right, the window control utility program 203 selects the window identifier, which corresponds to the window that is to be set as the next active window, from among the window identifiers stored in the table T1 in the order of registration of the window identifiers in the table T1 (step S302).

Then, the window control utility program 203 sends to the OS 201 a message for requesting that the window corresponding to the window identifier, which is selected from the table T1, be set to be the active window, and sets the window corresponding to the selected window identifier to be the active window (step S303). In step S303, the window control utility program 203 also executes the process of sending to the OS 201 a command to request current position information corresponding to the selected window identifier, and acquiring from the OS 201 the position information indicative of the current position of the window corresponding to the selected window identifier. Then, based on the acquired position information, the window control utility program 203 moves the mouse cursor 301 onto the window corresponding to the selected window identifier (step S304).

On the other hand, when it is determined that the scroll wheel 125 is shifted to the left, the window control utility program 203 selects the window identifier, which corresponds to the window that is to be set as the next active window, from among the window identifiers stored in the table T1 in an order reverse to the order of registration of the window identifiers in the table T1 (step S305). Subsequently, the window control utility program 203 executes the processes of steps S303 and S304.

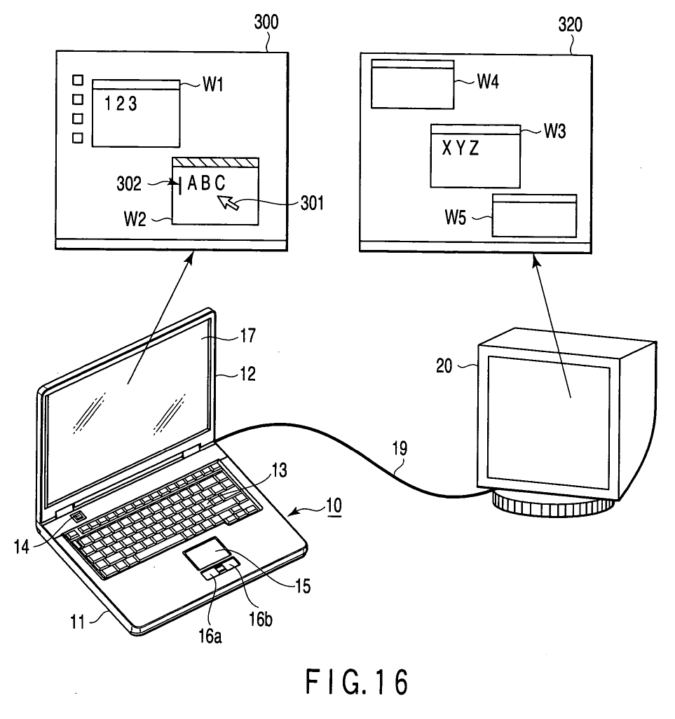

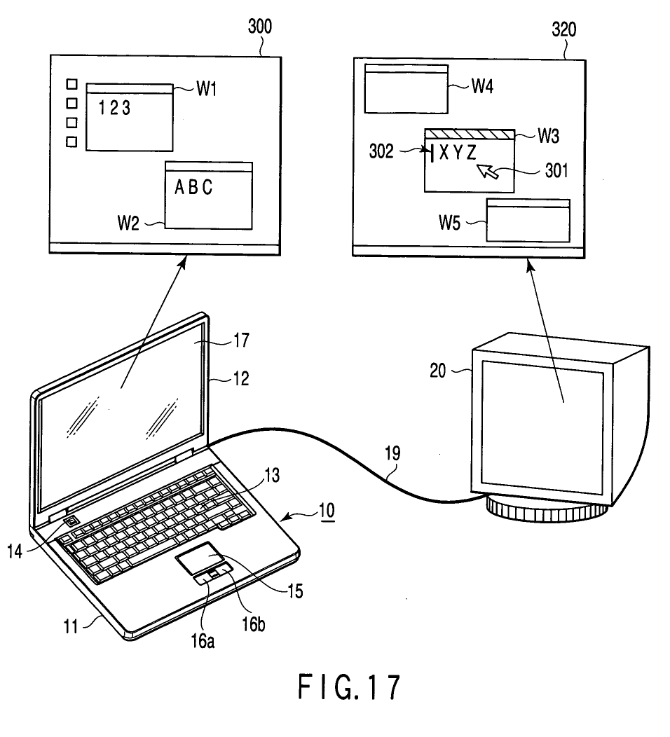

Next, referring to FIG. 16 and FIG. 17, a description is given of a case where the window control process (window identifier registration process, window identifier deletion process and window identifier switch process) of the present embodiment is applied to a multi-display system.

A CRT monitor 20 is connected to the computer 10 over a cable 19. The OS 201 has a function of dividing a single virtual screen into two display areas, displaying a screen image of one of the display areas on the display screen 300 of the LCD 17, and displaying a screen image of the other display area on a display screen 320 of the CRT monitor 20. On the virtual screen, windows W1 to W5 are arranged. The windows W1 and W2 are present on one display area, and the windows W3, W4 and W5 are present on the other display area. In this case, the windows W1 and W2 are displayed on the display screen 300, and the windows W3, W4 and W5 are displayed on the display screen 320.

Assume now that the window W1 is the active window, and the mouse cursor 301 and input cursor 302 are displayed on the window W1.

If the scroll wheel 125 is shifted to the right by the user, the active window is switched, as shown in FIG. 17, from the window W1 on the display screen 300 to the window W3 on the display screen 320. In addition, the mouse cursor 301 and input cursor 302 are moved onto the window W3 on the display screen 320.

As has been described above, in the case where the window control process of the present embodiment is applied to the multi-display system, the active window can easily be switched between the window on the display screen 300 and the window on the display screen 320.

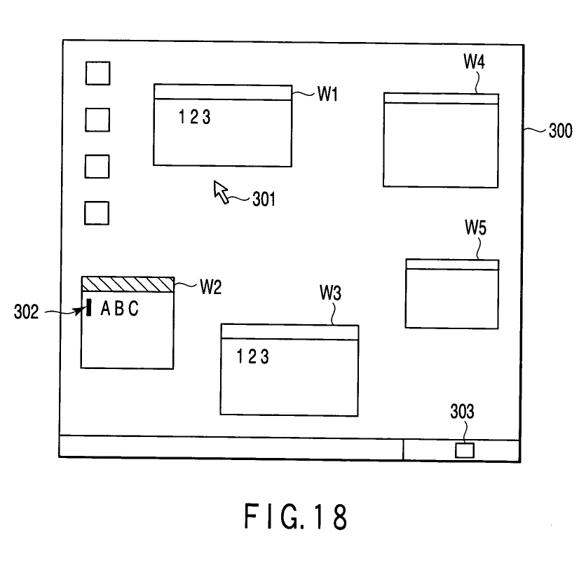

Next, referring to FIG. 18, a description is given of the case where the operation of the right button switch 16b or right button switch 124 is used for the first event, and the left button switch 16a or left button switch 123 is used for the second event.

Normally, various functions are already assigned to the right button switch 16b or right button switch 124, and to the left button switch 16a or left button switch 123. Thus, in the present embodiment, the window switch mode is used as a dedicated mode for executing the window control process in response to the operation of the right button/left button of the pointing device. Only when the window switch mode is enabled, the operation of the right button switch 16b or right button switch 124 is used for the first event, and the operation of the left button switch 16a or left button switch 123 is used as the second event.

As shown in FIG. 18, an icon 303 for enabling/disabling the window switch mode is displayed on a lower right part of the display screen 300. If the icon 303 is clicked, the window switch mode is enabled. In this case, the right button switch 16b or right button switch 124 is used as a switch for inputting the first event, and the left button switch 16a or left button switch 123 is used as a switch for inputting the second event. If the icon 303 is clicked once again, the window switch mode is disabled. In this case, if the right button switch 16b or right button switch 124 is pressed, the normal function that is assigned to the right button switch is executed, and if the left button switch 16a or left button switch 123 is pressed, the normal function that is assigned to the left button switch is executed.

By using the window switch mode, for example, the “→” key may be used as the switch for inputting the first event, and the “←” key may be used as the switch for inputting the second event.

As has been described above, according to the present embodiment, an arbitrary number of windows, which are to be controlled, can be designated in advance. Thus, the window control process for switching the active window can be executed only for a number of windows to be controlled. If the user simply registers some desired windows in advance as objects of control by using the window identifier registration process, it becomes possible to easily switch the active window between these windows.

In the present embodiment, the window identifier registration process is executed by using the “window registration” item of the operation menu 310 that is displayed in accordance with the right click operation of the mouse. Alternatively, the window identifier registration process may be started upon the pressing of a specific key on the keyboard. In this case, for example, a window under the current mouse cursor is designated as a window that is the object of control, and the window identifier of the designated window is registered. Thereby, the user can use the window identifier registration process by using an input device other than the mouse.

The window control process of the present embodiment is all realized by a computer program. Thus, if the computer program is simply installed in an ordinary computer through a computer-readable memory medium, the same advantages as in the present embodiment can easily be realized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus capable of displaying a plurality of windows, comprising:
an input device;
a memory device;
a window identifier storage unit which stores, in the memory device, window identifiers which correspond to at least two windows of the plurality of windows, which are designated as to-be-controlled windows by an operation of the input device; and
a window control unit which executes a process of switching an active window between the windows corresponding to the window identifiers stored in the memory device, when an event of requesting switch of the active window is input from the input device.

2. The information processing apparatus according to claim 1, further comprising a window identifier deletion unit which deletes, from the memory device, a window identifier corresponding to a window which is designated to be excluded from the to-be-controlled windows by an operation of the input device.

3. The information processing apparatus according to claim 1, wherein the window control unit includes means for moving a position of a mouse cursor onto a window which is newly set as the active window.

4. The information processing apparatus according to claim 1, wherein the plurality of windows are managed by an operating system, and
the window control unit includes means for selecting one of the window identifiers stored in the memory device in response to input of the event, and sending to the operating system a message for requesting that a window corresponding to the selected window identifier be set to be the active window.

5. The information processing apparatus according to claim 1, wherein the plurality of windows are managed by an operating system, and
the window control unit includes means for selecting one of the window identifiers stored in the memory device in response to input of the event, and sending to the operating system a message for requesting that a window corresponding to the selected window identifier be set to be the active window, to set the window corresponding to the selected window identifier to be the active window, and means for acquiring, from the operating system, position information indicative of a position of the window corresponding to the selected window identifier, and moving a position of a mouse cursor onto the window corresponding to the selected window identifier based on the acquired position information.

6. The information processing apparatus according to claim 1, wherein the event includes one of a first event and a second event, and
the window control unit includes means for successively setting the windows, which correspond to the window identifiers stored in the memory device, to be the active window in a first order each time the first event is input, and means for successively setting the windows, which correspond to the window identifiers stored in the memory device, to be the active window in a second order reverse to the first order each time the second event is input.

7. A program which is stored in a computer-readable medium and causes a computer to execute a process of controlling a plurality of windows which are displayed on a display screen of the computer, comprising:
causing the computer to execute a process of storing, in a memory device of the computer, window identifiers which correspond to at least two windows of the plurality of windows, which are designated as to-be-controlled windows by an operation of an input device of the computer; and
causing the computer to execute a window control process of switching an active window between the windows corresponding to the window identifiers stored in the memory device, when an event of requesting switch of the active window is input from the input device.

8. The program according to claim 7, further comprising causing the computer to execute a window identifier deletion process of deleting, from the memory device, a window identifier corresponding to a window which is designated to be excluded from the to-be-controlled windows by an operation of the input device.

9. The program according to claim 7, further comprising causing the computer to execute a process of moving a position of a mouse cursor onto a window which is newly set as the active window.

10. The program according to claim 7, wherein the plurality of windows are managed by an operating system, and
the window control process includes a process of selecting one of the window identifiers stored in the memory device in response to input of the event, and sending to the operating system a message for requesting that a window corresponding to the selected window identifier be set to be the active window.

11. The program according to claim 7, wherein the plurality of windows are managed by an operating system, and
the window control process includes a process of selecting one of the window identifiers stored in the memory device in response to input of the event, and sending to the operating system a message for requesting that a window corresponding to the selected window identifier be set to be the active window, to set the window corresponding to the selected window identifier to be the active window, and a process of acquiring, from the operating system, position information indicative of a position of the window corresponding to the selected window identifier, and moving a position of a mouse cursor onto the window corresponding to the selected window identifier based on the acquired position information.

12. The program according to claim 7, wherein the event includes one of a first event and a second event, and
the window control process includes a procedure of causing the computer to execute a process of successively setting the windows, which correspond to the window identifiers stored in the memory device, to be the active window in a first order each time the first event is input, and a procedure of causing the computer to execute a process of successively setting the windows, which correspond to the window identifiers stored in the memory device, to be the active window in a second order reverse to the first order each time the second event is input.
